(19) United States
(12) Patent Application Publication
(10) Pub. No.: US 2002/0138299 A1
(43) Pub. Date: Sep. 26, 2002

(54) Method and process for creating and supporting a new financial instrument with constituents allocated into tranches

(76) Inventor: Scott Nations, Chicago, IL (US)

Correspondence Address: Scott Nations, 1661A N. Dayton, Chicago, IL, 60614, US

(21) Appl. No.: 10/103,265

(22) Filed: Mar. 20, 2002

Related U.S. Application Data
(60) Provisional application No. 60/277,929, filed on Mar. 21, 2001.

(51) Int. Cl. G06F 17/60

(52) U.S. Cl. 705/1

(57) ABSTRACT

This invention provides methods and processes for creating a new investment vehicle which reduces risk while investing in a single asset or index. A fund invests the bulk of its assets in an asset and allocates a fixed annual percentage of its assets to the purchase of hedging derivatives. Each period's investment is treated as a separate tranche or slice of the fund. This allows for subsequent redemptions to be handled appropriately.

### RELATED APPLICATIONS

This application is entitled to the benefit of Provisional Patent Application Ser. No. 60/277,929, filed Mar. 21, 2001.

### STATEMENT REGARDING FEDERALLY SPONSORED RESEARCH

Not applicable.

### REFERENCE TO SEQUENCE LISTING, A TABLE, OR A COMPUTER PROGRAM LISTING COMPACT DISK APPENDIX

Not applicable.

### FIELD OF THE INVENTION

This invention relates to systems and methods for creating and maintaining a new investment vehicle which includes an asset and derivative, hedging securities. More particularly, the present invention relates to a method and process for creating and supporting a financial instrument with less risk and multiple derivative strategies. The tranches provide for redemptions by existing investors without allocating specific derivative positions to specific shareholders.

### BACKGROUND

Thousands of types of assets exist. Many are investment vehicles which use capital to generate a financial return. One of the most familiar is mutual funds, which may invest in one or several asset classes such as stocks, bonds, precious metals, etc. Others might include a farmer's portfolio of grain in storage or growing in his fields, or a portfolio of electrical power commitments that an electrical power distributor has accumulated.

Risk is inherent in almost all assets or investment vehicles. For example, the owner of a mutual fund might see the value of his holdings decrease due to poor performance of the constituent companies, from general economic conditions, or from a decline in value of physical assets held by the fund (e.g. precious metals). The current method of modulating risk generally entails spreading capital across multiple assets or asset classes.

This method of risk modulation has several disadvantages. First, by investing in many asset classes, investors often give up significant potential appreciation for greater safety. For example, by moving capital from stocks to certificates of deposit investors are more assured of getting their money back but are very unlikely to become wealthy due to their investments. This diversification across multiple asset classes changes the entire portfolio's risk/reward profile. The portfolio's expected return is the simple weighted average return of its constituents while the portfolio's risk is less than the weighted average of the constituents. Some of the risky uncertainty of the expected return of each constituent is diversified away because the other constituents in the portfolio rise and fall in price at different times in different amounts. The problem with this approach is that the price that an investor pays in exchange for a reduction of risk and no loss of return in his portfolio is that he must give up the possibility of earning a return potentially greater than the expected return of the portfolio. In other words, while diversification across asset classes reduces risk, it reduces potential reward to such a degree that a diversified portfolio, as diversification is outlined above, has nearly zero chance of outperforming the overall market.

Additionally, when several asset classes are involved it also becomes confusing and expensive to perform the analysis needed to pick and choose from the available asset classes. Expenses for analysis of potential investments, trade execution, and other explicit costs can be high. In addition, the hidden costs of executing these strategies also have a significant impact on their overall results. Hidden costs include the width of the bid/ask spread and slippage, as the supply or demand of a fund's own trading adversely affects the price paid or received.

This method of risk modulation may not even be possible for some types of users such as a single crop farmer, with considerable ownership of that crop in storage as well as growing in his fields, or a producer of precious metals that has built up a significant stockpile of bullion.

Currently, when other means of modulating risk are used, such as derivatives, the decision to do so is ad hoc and made due to fear or greed on the part of the owner or vehicle manager rather than as part of a systematic plan. For example, a mutual fund manager may feel that stock prices are overvalued but doesn't want to forego potential appreciation by selling assets. He may decide to buy put options on a portion of his portfolio. Put options give their owner the right to sell an asset at an agreed upon price within a certain period of time. The buyer of the option pays the seller of the option for the right. But how much money should the fund manager allocate to this strategy? Which options should the he buy? How many should he buy? Over what timeframe? How can he get the best protection at the best price? If stock prices don't fall what should he do? If he's buying because of fear, are other investors doing the same thing, thereby driving up the price of protective put options? Investors don't know what percentage of the portfolio is dedicated to protective strategies (or income generation if the put buying model is replaced with a call selling one) now or at any time in the future.

While a few specialized instruments (e.g. Merrill Lynch's Market Index Target-Term Securities®, also know as MITTS®) use derivatives to modulate risk, most often by establishing a floor below which the value of the investment can not fall if held for a specific period of time, these vehicles have significant disadvantages. They are illiquid and offer returns significantly below the underlying asset. They eventually expire which may require reinvestment and income recognition at an inopportune time. Additionally, since they buy zero-coupon bonds and equity call options they have interest imputed to them each year for tax purposes, even though they offer no current period cash flow with which to pay these taxes. Thus they are appropriate only for tax deferred accounts. This also means that the funds don't receive the dividends that the present invention would receive. In addition the value of these instruments in the secondary market is affected by the credit worthiness of the issuer. In the case of MITTS® that would be Merrill Lynch.

### SUMMARY

The present invention relates to a method and process for creating a portfolio with an asset or basket of assets and a sub-portfolio of hedging derivatives. The assets are divided into daily tranches or slices. It results in a new financial instrument with a unique risk/reward profile.

The portfolio is comprised of an asset overlay and a sub-portfolio of hedging derivative securities. The overlay forms the bulk of the portfolio and is the underlying asset that is ‘laid over’ the sub-portfolio of derivatives. The sub-portfolio is constructed and executed by determining the percentage of assets to be spent or received in the form of derivative premium. In one embodiment a fund will invest the vast majority of its assets in the securities comprising an index. The fund will have predetermined that it is going to spend p% of assets annually to purchase protective put options in order to hedge a portion of downside risk. The fund manager will direct the purchase of the constituent index overlay. He will then calculate how much net premium is to be spent for protective strategies for that time period, generally one business day. In this embodiment this would be calculated as Overlay Assets×p% /260 (the number of business days in a calendar year)=$z.

He will analyze the put options available for purchase either on a recognized exchange such as the Chicago Board Options Exchange or over the counter from an investment bank or trading firm as well as the synthetic options available. Synthetic options might include long-dated credit spreads which tend to act like put options. He will determine the best options for the portfolio given specifics of each put such as expiration, strike price, etc. such that total premium paid for these options equals $z. He'll then direct the purchase of those put options. This is repeated for each day or other predetermined time period. Each period's overlay and put purchases are treated as a separate slice or tranche to be ‘unwound’ LIFO in the event of fund redemptions. Treating each period's overlay and put purchases as a tranche insures that the appropriate amount of put premium is sold for a given level of redemption. The result is a new vehicle with a unique risk/return profile that uses a precise predetermined percentage of assets on protective strategies.

In another embodiment a fund may invest the vast majority of it's assets in a security and choose to generate income of y% annually through the sale of call options on that security. The fund manager would calculate the net premium to be received for that time period given the predetermined percentage to be generated annually. The fund manager would then analyze the call options available on the security, including synthetic options such as long-dated credit spreads, select those strategies most appropriate given the variables discussed above and direct the execution of those strategies such that net premium received equals the calculation made above. This is repeated for each day or other predetermined time period. Again, each period's overlay and call sales are treated as a slice or tranche to be ‘unwound’ LIFO in the case of fund redemptions.

Other Objects and Advantages of the Present Invention Include:

(a) A new investment vehicle with unique attributes

(b) An investment vehicle with a new risk/reward profile

(c) A less risky instrument with potential return greater than the expected return of a diversified portfolio

(d) A vehicle with greater investment returns

(e) A vehicle with greater investment returns given a certain level of risk

(f) A vehicle which shoulders less risk for a given level of return

(g) A more tax efficient vehicle

(h) A more liquid vehicle

(i) Investors will know what percentage of their assets are being deployed to or are resulting from hedging strategies.

(j) Investors will know the minimum performance of their fund relative to the underlying asset or benchmark.

(k) Increased efficiency for the investor interested in hedging assets with derivatives

(l) The tranches will be diversified in terms of option expirations, strike prices, counterparties, strategies and other attributes.

(m) The average price paid for the derivatives will be smoothed.

(n) The portfolio will bear less market impact costs.

(o) Any number of funds can track the same asset, security or index but offer a range of risk/reward profiles by allocating or harvesting different percentages to/from hedging strategies.

(p) The use of hedging derivatives will be constant and consistent.

(q) Tranches provide for redemptions by existing investors without allocating specific positions to specific investors.

(r) Intended allocation to derivative strategies is more precisely achieved since the portfolio doesn't execute derivatives on the total value but on the overlay value. Thus the portfolio doesn't ‘buy options for options’.

(s) Value of the vehicle would be independent of the creditworthiness of the managers or issuer.

(t) Further objects and advantages of the present invention will become apparent from a consideration of the drawings and ensuing description.

### DESCRIPTION OF DRAWINGS

FIG. 1 illustrates the method of the preferred embodiment of the present invention if net new period investment is nonnegative.

FIG. 2 illustrates the method of the preferred embodiment of the present invention if net new period investment is negative.

### DETAILED DESCRIPTION OF INVENTION

While the present invention will be described fully hereinafter with reference to the accompany drawings, in which a particular embodiment is shown, it is understood at the outset that persons skilled in the art may modify the invention herein described while still achieving the desired result of this invention. Accordingly, the description which follows is to be understood as a broad informative disclosure directed to persons skilled in the appropriate arts and not as limitations of the present invention.

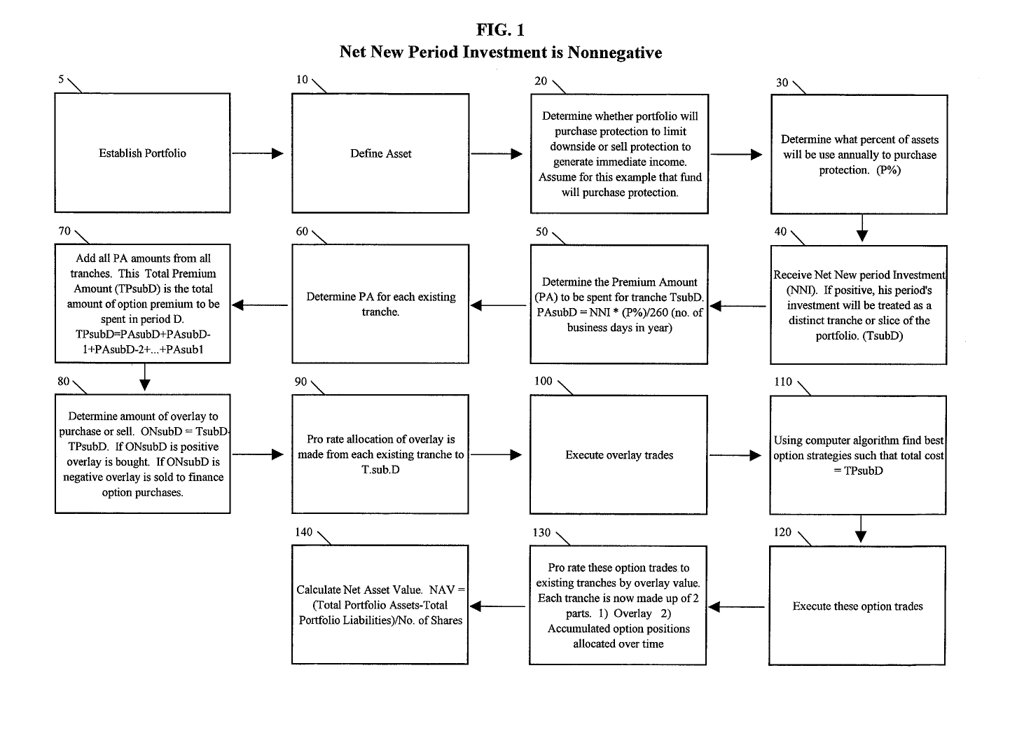

First, a portfolio is established, Referring to FIG. 1, step 5.

An asset is selected for the portfolio to invest in, step 10. “Asset” is a term of art that broadly refers to cash, investments (equity securities and/or debt securities), including foreign or domestic equities, indexes, options, warrants, bonds, notes, limited partnership interests, private placement securities or otherwise, or commodities, futures, bank loan syndication interests, real estate and novel assets that are traded such as pollution rights (including global warming and air/water pollution rights), energy (including electricity), weather, or insurance claim interests, or any other tradable assets or combination thereof. The portfolio will participate in a single asset for the life of the portfolio. This asset forms the bulk of the portfolio and is ‘laid over’ the portfolio of derivative instruments.

It is determined whether the portfolio will purchase protective derivatives, for example put options, or sell derivatives that limit potential upside but produce immediate income, for example call options, step 20. This decision will be unchanging for the life of the portfolio.

It is determined what annual percentage of assets is to be devoted to protective strategies (put buying) or generated by income producing (call selling) strategies, step 30. This percentage will be unchanging for the life of the portfolio.

A Net New period Investment (NNI) is received, step 40. When the portfolio is initially funded this number will be positive. Any future Net New period Investment can be positive, negative (redemptions) or zero. If a period's investment is positive, it will be treated as a distinct tranche or slice of the fund.

A Premium Amount (PA) to be spent to purchase protective derivatives for a current period tranche is calculated, step 50. For new tranches, PA is determined using Net New period Investment (NNI). As an example, if a portfolio is to spend 1.5% of it's assets annually on protective strategies, executed each business day, and if on a portfolio's first day of operation a net new investment of $1,000,000 is received, the portfolio will spend $57.69 on this day to purchase protective derivative strategies.

$57.69=($1,000,000*1.5%)/260

A generalized formula for determining PA for a new tranche is

PA.sub.NEW=(NNI.multidot.P%)/NP

where PA.sub.NEW is the Premium Amount to be spent for the new tranche; NNI is the Net New period Investment; P% is the unchanging annual percentage of assets devoted to derivative strategies; and NP is the number of periods in the calendar year, usually business days.

NNI is reduced by PA to determine the value of an overlay portion (O.sub.NEW) of the new tranche.

For existing tranches the PA is calculated using only the overlay portion of the tranche. This prevents buying ‘puts for puts’.

A generalized formula for determining the Premium Amount for an existing tranche is

PA.sub.D=(O.sub.D.multidot.P)/NP

where PA.sub.D is the Premium Amount to be spent on derivative strategies for the period D tranche; O.sub.D is the value of the Overlay portion of the period D tranche; P% is the fixed annual percentage of assets to be spent on derivative strategies; and NP is the number of periods in a calendar year, usually business days.

Premium Amount is calculated for each existing tranche, step 60.

Premium Amount for all existing tranches is summed, step 70. This is the total amount to be spent on protective derivative strategies in period D. A generalized formula for determining the total amount to be spent on protective derivative strategies in period D is

TP.sub.D=PA.sub.D+PA.sub.D-1+PA.sub.D-2+ . . . +PA.sub.1

where TP.sub.D is A Total Premium to be spent on derivative strategies in time period D; PA.sub.D-1 is the Premium Amount for the immediately preceding tranche; PA.sub.D-2 is the Premium Amount for the next preceding tranche, etc and PA.sub.1 is the Premium Amount for the oldest existing tranche.

The amount of overlay assets to be actually purchased or sold on the open market is determined, step 80. If T.sub.D is less than TP.sub.D then overlay assets will be sold to provide cash for option purchases.

In the example above this would be

$1,000,000−$57.69=$999,942.31

of overlay assets would be purchased

A generalized formula for determining the actual amount of overlay assets to be purchased (sold) on the open market is

ON.sub.D=T.sub.D−TP.sub.D

where ON.sub.D is an Overlay Net to be executed in time period D. A positive result indicates overlay assets will be purchased. A negative result indicates overlay assets will be sold to fund derivative strategy purchases.

On days when the fund has a large level of overlay but small Net New period Investment, the T.sub.NEW will be positive meaning that O.sub.NEW will be positive but ON.sub.NEW will be negative. On these days overlay must be sold to finance option purchases.

Efficient operation of the portfolio may be optimized if such overlay asset sales to generate cash strictly for option purchases are kept to a minimum, however. To insure efficient operation of the portfolio one or more mechanisms may be implemented to reduce these overlay sales. For example, an efficiency reserve of cash could be maintained. This reserve of cash could be used to fund option purchases and might be replenished through net new positive investment or less frequent overlay sales.

The overlay portion (O.sub.D) of T.sub.D and the overlay net (ON.sub.D) may be very different since O.sub.D reflects the overlay assets of that tranche while ON.sub.D is simply a means of netting the new investment inflow with the needed outflow for option purchases. But at this point there would be a discrepancy between the actual amount of overlay assets in the portfolio and the aggregate of overlay in every tranche if we executed the overlay trades previously calculated. Again, this is because of the difference between O.sub.D and ON.sub.D. To rectify this, pro rata allocation of overlay is made from each existing tranche to T.sub.D, step 90. This has the effect of each tranche ‘paying T.sub.D back’ for financing D period option purchases. Each tranche has now paid for the options from which it will benefit.

Overlay trades calculated previously are executed, step 100.

TP.sub.D is entered into an evaluation model, step 110, which incorporates an algorithm to identify the best derivative candidates given several criteria, such that TP.sub.D equals the net premium for the identified derivative candidates. The derivative pricing and evaluation formulas differ for each asset class and type of option exercise limitations. A complete list of pricing and evaluation formulas for all asset classes can be found in books such as Espen Gaarder Haug's The Complete Guide to Option Pricing Formulas. All formulas are used in a computer program to calculate specific information for each available derivative. The information calculated includes how quickly the value of the derivatives erode (theta), how the values respond to changes in volatility (vega), how the values respond to changes in price of the underlying asset (delta), and how they respond to other changes. These values are collectively called ‘greeks’. The greeks for each derivative will be evaluated subjectively in order to determine the best derivatives for the portfolio.

Once the best derivative candidates are identified using the computer algorithm, these derivative strategy trades are executed, step 120. These trades may be executed on a recognized derivative exchange such as the Chicago Board Options Exchange or over the counter with an investment bank or trading firm.

These derivative trades are allocated to existing tranches, pro rata by tranche overlay value, step 130.

At this point a tranche is made up of two parts. First, the asset overlay, that is the underlying securities, bonds, notes, etc. that comprise the bulk of the tranche's value. Second, a sub-portfolio of derivative instruments that hedge the risk inherent in the overlay portion of the tranche. The derivative instruments in a tranche have been allocated over time. As some derivative instruments expire, other derivatives are pro rata allocated to the tranche based on the overlay's percentage of overall overlay value.

Calculate a Net Asset Value (NAV) for the fund, step 140. The NAV is the price that new investors pay for each share of the fund (plus any commissions, loads, or sales charges) and the price that exiting investors receive (less any commissions or loads) for each share of the fund. A generalized formula for NAV is

NAV=(Total Fund Assets−Total Fund Liabilities)/Number of shares outstanding

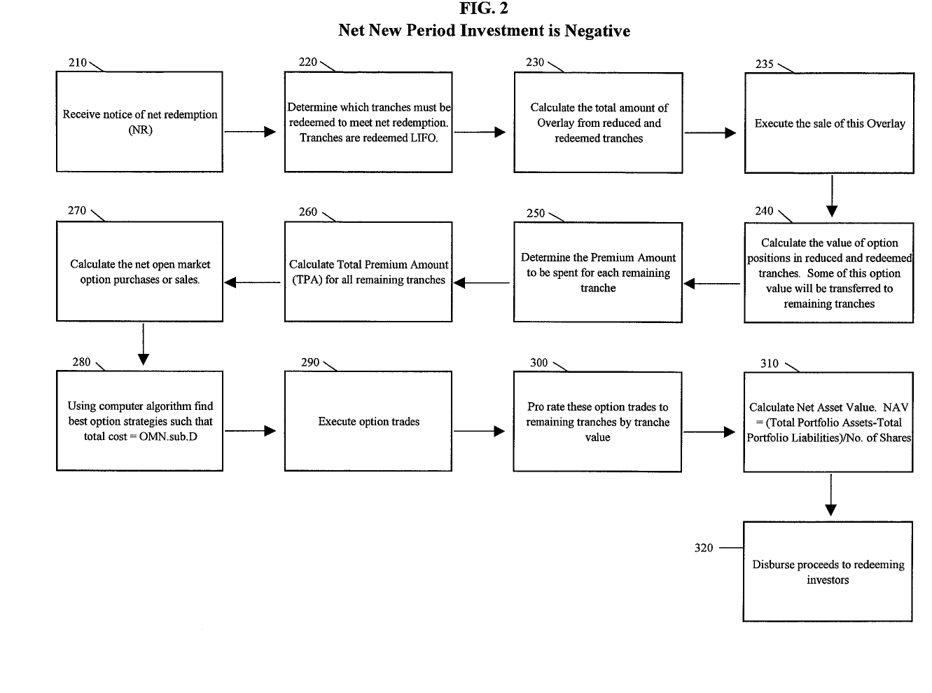

Periods in which Net New period Investment is negative are handled differently. Referring to FIG. 2, the portfolio receives notice of a Net Redemption (NR), step 210. At this point the fund may be made up of multiple tranches. Each tranche is made up of two parts. First, the asset overlay, that is the underlying securities, bonds, notes, etc. that comprise the bulk of the tranche's value. Second, derivative instruments that hedge the risk inherent in the overlay portion of the tranche. The derivative instruments in a tranche have been allocated over time. As some derivative instruments expire, other derivatives are pro rata allocated to the tranche based on the tranche overlay's percentage of the overall value of the overlay.

Determine which tranches must be redeemed to satisfy the Net Redemption, step 220. Tranches will be redeemed LIFO. The oldest tranche redeemed may be only partially redeemed.

Another method of expressing this is

NR=(T.sub.D-1)+(T.sub.D-2)+ . . . +(X%.multidot.T.sub.D-Y)

Where NR is the Net Redemption; T.sub.D-1 is the newest tranche redeemed; X is the percent of the oldest tranche that is redeemed and T.sub.D-Y is the oldest tranche redeemed.

Calculate the overlay to be sold from redeemed tranches, step 230.

A generalized formula for calculating the overlay to be sold from redeemed tranches is

OS=(O.sub.D-1)+(O.sub.D-2)+ . . . +(X%.multidot.O.sub.D-Y)

where OS is the Overlay to be Sold; O.sub.D-l is the overlay from the newest tranche to be redeemed; O.sub.D-Y is the overlay from the oldest tranche and X is the percentage of the oldest tranche that is redeemed.

The overlay sale is executed, step 235.

Calculate the value of options to be sold or allocated from redeemed tranches, step 240. Existing option positions from tranches that are redeemed may be allocated to remaining tranches instead of selling them only to have to buy options for remaining tranches.

A generalized formula for calculating the option premium to be sold or allocated is

SOA.sub.D=(AOP.sub.D-1)+(AOP.sub.D-2)+ . . . +(X%.multidot.AOP.sub.D-Y)

where SOA.sub.D is a total option premium to be Sold Or Allocated in period D; AOP.sub.D-1 is a total Allocated Option Premium from tranche D-1; AOP.sub.D-Y is the Allocated Option Premium from the oldest tranche and X is the percentage of the oldest tranche that is redeemed.

Determine the Premium Amount (PA) to be spent for each remaining tranche, step 250.

A generalized formula for the Premium Amount for an existing tranche X is

PA.sub.X=(O.sub.X.multidot.P%)/NP

where PA.sub.X is the Premium Amount to be spent on derivative strategies for tranche X; O.sub.X is the value of the overlay portion of tranche X; P% is the fixed annual percentage of assets to be spent on derivative strategies; and NP is the number of periods in a calendar year, usually business days.

Premium Amount for all remaining tranches is summed, step 260, resulting in Total Premium or TP.sub.D. This is the total amount to be spent on protective strategies in Period D, the value of options allocated to remaining tranches instead of sold, or a combination of both.

At this point the amount of overlay to be sold has been determined and this sale has been executed. The total amount of option premium to be disposed of, either through allocation to remaining tranches or through open market sale has been determined. Finally, the amount of option premium we must acquire, either through open market purchase or allocation from reduced or redeemed tranches has been determined.

Calculate a net open market option purchase or sale amount, step 270.

A generalized formula for calculating the open market net is

OMN.sub.D=TP.sub.D−SOA.sub.D

where OMN.sub.D is an Open Market Net option purchase or sale amount; TP.sub.D is the Total Premium, the total amount to be spent on protective strategies in Period D, and SOA.sub.D is the total option premium from redeemed and reduced tranches which must be sold or allocated.

OMN.sub.D is entered into an evaluation model, step 280, which incorporates an algorithm to identify the best derivative candidates given several criteria, such that OMN.Sub.D equals the net premium for the identified derivative candidates. The derivative pricing and evaluation formulas differ for each asset class and type of option exercise limitations. A complete list of pricing and evaluation formulas for all asset classes can be found in books such as Espen Gaaarder Haug's The Complete Guide to Option Pricing Formulas. All formulas are used in a computer program to calculate specific information for each available derivative. The information calculated includes how quickly the value of the derivatives erode (theta), how the values respond to changes in volatility (vega), how the values respond to changes in price of the underlying asset (delta), and how they respond to other changes. These values are collectively called ‘greeks’. The greeks for each derivative will be evaluated subjectively in order to determine the best derivatives for the sub-portfolio.

Once the best derivative candidates are identified using the computer algorithm, these trades are executed, step 290, on a recognized derivative exchange such as the Chicago Board Options Exchange or over the counter with an investment bank or trading firm.

Pro rata allocate transferred and purchased option positions to remaining tranches by tranche overlay value, step 300.

Calculate the Net Asset Value (NAV) for the fund, step 310. The NAV is the price that new investors pay for each share of the fund (plus any commissions, loads, or sales charges) and the price that exiting investors receive (less any commissions or loads) for each share of the fund. A generalized formula for NAV is

NAV=(Total Fund Assets−Total Fund Liabilities)/Number of shares outstanding

Disburse proceeds, step 320, to redeeming investors.

I claim:

1. A method of administering a portfolio which spends a precise, predetermined, percentage of said portfolio's value to purchase protective derivative instruments, thereby hedging risk, the method comprising
(a) accumulating an asset, and
(b) accumulating hedging derivative instruments maintained such that the cost of said hedging derivative instruments is a precise, predetermined percentage of value of said portfolio.

2. The method for administering a portfolio as claimed in claim 1, wherein the asset is a basket of common stocks similar to a recognized stock index and the derivative instruments purchased are put options on said stock index.

3. The method for administering a portfolio as claimed in claim 1, wherein the portfolio is maintained by treating each time period's investment as a tranche, or slice, of said portfolio, said tranche maintained until redeemed.

4. The method as claimed in claim 1, wherein the asset is a group of contractual promises.

5. A method of administering a portfolio which generates a precise, predetermined, percentage of said portfolio's value by selling protective derivative instruments, thereby hedging risk, the method comprising
(a) accumulating an asset, and
(b) accumulating hedging derivative instrument commitments maintained such that the income from said hedging derivative instrument commitments is a precise, predetermined, percentage of value of said portfolio.

6. The method for administering a portfolio as claimed in claim 2, wherein the asset is a basket of common stocks similar to the Standard and Poors 500 stock index and the derivative instruments sold are call options on the Standard and Poors 500 stock index.

7. The method for administering a portfolio as claimed in claim 2, wherein the portfolio is maintained by treating each time period's investment as a tranche, or slice, of said portfolio, said tranche maintained until redeemed.

8. The method as claimed in claim 2, wherein the asset is a group of contractual promises.
